(19) United States
(12) Patent Application Publication
(10) Pub. No.: US 2026/0305647 A1
(43) Pub. Date: Oct. 8, 2026

(54) A CONFECTIONERY PRODUCT AND A METHOD FOR PRODUCING A CONFECTIONERY PRODUCT

(71) Applicant: Swedian Foods, LLC, Newport Beach, CA (US)

(72) Inventor: Rohit Walia, Buena Park, CA (US)

(73) Assignee: Swedian Foods, LLC, Newport Beach, CA (US)

(21) Appl. No.: 19/483,616

(22) PCT Filed: Jun. 17, 2024
(86) PCT No.: PCT/US2024/034256

§ 371 Date: Nov. 12, 2025

Related U.S. Application Data
(60) Provisional application No. 63/508,513, filed on Jun. 16, 2023.

(51) Int. Cl. A23G 3/46; A23G 3/42; A23G 3/48; A23L 33/12

(52) U.S. Cl. CPC A23G 3/46; A23G 3/42; A23G 3/48; A23L 33/12

(57) ABSTRACT

Disclosed herein is a confectionery product, in accordance with some embodiments. Accordingly, the confectionery product may include at least one product component, an esterified propoxylated glycerol, and at least one sweetener. Further, the at least one product component may include at least one of a dairy product and a flour of at least one of wheat and chickpea. Further, the esterified propoxylated glycerol may be present in an amount ranging between 1% and 38% of the total amount of the confectionery product. Further, the at least one sweetener may be present in an amount ranging between 1% and 40% of the total amount of the confectionery product.

### REFERENCE TO RELATED APPLICATIONS

This application is a US National Phase application for the PCT application PCTUS2434256, titled “A Confectionery Product And A Method For Producing A Confectionery Product”, filed on Jun. 17, 2024, which in turn claims the benefit of U.S. Provisional Patent Application No. 63508513, titled “A Low-Gi And Low-Calorie Edible Item Comprising A Composition Of Esterifiedpropoxylated Glycerol And Natural Sweeteners”, filed Jun. 16, 2023, which is incorporated by reference herein in its entirety.

### FIELD OF THE INVENTION

Generally, the present disclosure relates to the field of food or edible material: processes, compositions, and products. More specifically, the present disclosure relates to a confectionery product and a method for producing a confectionery product.

### BACKGROUND OF THE INVENTION

The field of food or edible material: processes, compositions, and products, may be technologically important to several industries, business organizations, and/or individuals. In particular, the use of food or edible material: processes, compositions, and products, is prevalent for low-GI and low-calorie edible items.

Traditional Indian sub-continental sweets, which are referred to colloquially as Mithai, traditionally are calorie-dense, high-sugar, and high-fat in composition. With the ever-growing threat of major diseases such as diabetes, there are limited solutions that deliver a similar experience without impacting ‘glucose spikes.’ Current solutions on the market provided by manufacturers, although labeled sugar-free, still deliver the dangerous effects of sugar, in addition to the high-calorie experience. These products also require refrigeration. Current sweet items (or Mithai) on the market use Polyols like Maltitol, oligosaccharide fructans, Saccharin, and sucralose.

Another critical aspect when looking at diabetic or keto-friendly mithai is the amount of carbohydrates. The carbohydrates in current foods or dishes also spike blood sugar levels.

Therefore, there is a need for an improved confectionery product and a method for producing a confectionery product that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a confectionery product, in accordance with some embodiments. Accordingly, the confectionery product may include at least one product component, an esterified propoxylated glycerol, and at least one sweetener. Further, the at least one product component may include at least one of a dairy product and a flour of at least one of wheat and chickpea. Further, the esterified propoxylated glycerol may be present in an amount ranging between 1% and 38% of the total amount of the confectionery product. Further, the at least one sweetener may be present in an amount ranging between 1% and 40% of the total amount of the confectionery product.

Further disclosed herein is a confectionery product, in accordance with some embodiments. Accordingly, the confectionery product may include at least one product component, an esterified propoxylated glycerol, and at least one sweetener. Further, the at least one product component may include at least one of a dairy product and a flour of at least one of wheat and chickpea. Further, the esterified propoxylated glycerol may be present in an amount ranging between 1% and 38% of the total amount of the confectionery product. Further, the at least one sweetener may be present in an amount ranging between 1% and 40% of the total amount of the confectionery product. Further, the at least one sweetener may include a natural sweetener. Further, the natural sweetener may include at least one of Allulose, Stevia, and Erythritol.

Further disclosed herein is a method for producing a confectionery product, in accordance with some embodiments. Accordingly, the method may include a step of combining at least one product component comprising at least one of a dairy product and a flour of at least one of wheat and chickpea and at least one sweetener. Further, the method may include a step of adding an esterified propoxylated glycerol to the at least one product component. Further, the method may include a step of providing at least one treatment to the at least one product component and the at least one sweetener based on the adding for producing the confectionery product.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a table 100 listing ingredients of a confectionery product, in accordance with some embodiments.

FIG. 2 is a table 200 listing the ingredients of the confectionery product, the ingredients being in percent by amount in accordance with some embodiments.

FIG. 3 is a table 300 listing ingredients of a confectionery product, in accordance with some embodiments.

FIG. 4 is a flowchart of a method 400 for producing a confectionery product, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a confectionery product and a method for producing a confectionery product, embodiments of the present disclosure are not limited to use only in this context.

### Overview

The present disclosure describes a confectionery product and a method for producing a confectionery product.

Further, the confectionery product may include a low-glycemic index (GI) and low-calorie edible item comprising a composition of esterified propoxylated glycerol and natural sweeteners.

Further, the present disclosure describes a low-GI and low-calorie edible item comprising a composition of esterified propoxylated glycerol and natural sweeteners. Further, the edible item may include a sweet treat such as a mithai or barfi with reduced calories, no added sugar, and reduced fat, in addition to lowering cholesterol compared to traditional mithai.

Further, the disclosed composition may include a plurality of ingredients. Further, the plurality of ingredients may include Esterified Propoxylated Glycerol. Further, in an instance, the Esterified Propoxylated Glycerol may include esterified propoxylated glycerol (GRN No. 583). Further, in another instance, the Esterified Propoxylated Glycerol may include esterified propoxylated glycerol (GRAS 640). Further, in some embodiments, the Esterified Propoxylated Glycerol may be available in a spreadable version. Further, the plurality of ingredients may include anti-oxidants such as tocopherol (Vitamin E). Further, the esterified propoxylated glycerol may be a highly complex plant-based fat that requires some proprietary process to use. Further, the esterified propoxylated glycerol (EPGs) may be produced by splitting fats and oils into glycerol and fatty acids, reacting glycerol with propylene oxide to produce glycerol with propylene glycol units (PGUs) inserted on its hydroxyl groups and finally, the propylene glycol-substituted glycerol is reacted with fatty acids resulting in their esterification with the hydroxyl moieties of the PGUs to produce EPG. Further, a second ingredient of the plurality of ingredients may include a polyol. Further, the polyol may include a natural sweetener such as allulose (GRN No. 400, 498, and 893). Further, the edible item may have an increased shelf life. Further, the allulose may have a molecular formula of C₆H₁₂O₆ and a molecular weight of 180.16. Further, the natural sweetener may include erythritol. Further, the erythritol may have a molecular formula of C₄H₁₀O₄. Further, the Esterified Propoxylated Glycerol and the allulose may be currently unavailable in Europe and India but are GRAS by the US FDA. Further, the composition may be used to manufacture the edible items such as flavored yogurt, sweet bakery cookies, sweet general cake, sweet bread, sweet buns/rolls, ice cream, snack bars, gelatin gummy candy, and mithai or sweet dishes. Further, the mithai may include Agra Petha, Balushahi, Besan Laddu, Gajar Halwa, Rasgulla, Gulab Jamun, Jalebi (North Indian), Kalakand, Kesar Pista Barfi, Malai Peda, Doodh Peda, Kaju Barfi, Ras Malai, Patisa (Soan Papdi), etc. Further, the esterified propoxylated glycerol may be used between 1% and 38% in the composition. Further, the allulose may be used between 1% and 40% in the composition.

Further, in some embodiments, the composition may include a confectionery composition, wherein the confectionery composition comprises esterified propoxylated glycerol between 1% and 38% and allulose in a quantity between 1% and 40%. Further, the confectionery composition may be used to make a low-calorie, sugar free, low fat, and low GI sweet.

Further, in some embodiments, the edible item may include at least one of isomaltulose and trehalulose.

Further, in some embodiments, the edible item may include essential trace elements, soluble oligosaccharides, bulking agents, one or more nutritive sweeteners, etc.

Further, in some embodiments, the composition may include at least one of gelling agent, bulking sweetener agent, doctoring agent, flavors, actives, color, sensates, and high intensity sweetener. Further, the bulking sweetener agent may include at least one of sucrose, dextrose, fructose, maltose, maltodextrin, xylose, as well as sugar alcohols including but not limited to sorbitol, mannitol, xylitol, maltitol, lactitol, palatinit, and hydrogenated starch hydrolyzates such as Lycasin.

Further, in some embodiments, the composition may include high potency sweeteners including, but not limited to, thaumatin, aspartame, acesulfame K, sodium saccharin, glycyrrhizin, alitame, cyclamate, stevioside, and dihydrochalcones.

Further, the present disclosure relates generally to food or edible material: processes, compositions, and products. More specifically, the present disclosure describes a low-GI and low-calorie edible item comprising a composition of esterified propoxylated glycerol and natural sweeteners such as but not limited to Allulose and Stevia.

Further, the present disclosure describes a method of using a combination of esterified propoxylated glycerol, allulose, and erythritol to make a low GI sweet treat.

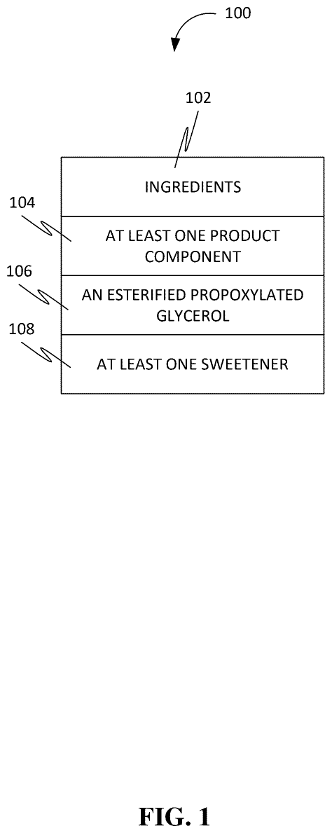

FIG. 1 is a table 100 listing ingredients of a confectionery product, in accordance with some embodiments. Further, the confectionery product may be Indian sweets, Indian sweet dishes, Mithai, etc. Further, the confectionery product may be a low glycemic index (GI) sweet treat, a low-GI and low-calorie edible item, an edible item, etc. Further, the table 100 may include a column 102 and three rows 104-108. Further, the table 100 may include three cells (column 102, row 104), (column 102, row 106), and (column 102, row 108). Further, the confectionery product may include at least one product component, an esterified propoxylated glycerol, and at least one sweetener.

Further, the cell (column 102, row 104) of the table 100 may be related to the at least one product component. Further, the at least one product component may include at least one of a dairy product and a flour of at least one of wheat and chickpea. Further, the dairy product may include one or more milk components of milk. Further, the one or more milk components may include lactose (Carbohydrates), milk proteins, water, milk minerals (ash), milk vitamins, milk fat, etc. Further, the one or more milk components may include lactose, milk proteins (such as Casein, Whey, etc.), water, milk minerals, milk vitamins, etc. Further, each of the one or more milk components may be present in a percentage of the total amount of the dairy product. Further, the dairy product does not contain milk fat. Further, the dairy product may include Chhena, Khoa (Mawa), Condensed milk, Malai (Clotted cream), etc. Further, the flour may include whole wheat flour, refined wheat flour, semolina, etc. Further, the flour may include a gram flour, etc. Further, the chickpea may include gram, Bengal gram, etc. Further, the flour may be a flour of one or more grains (such as Rice, Barley, Millet, Oats, Rye, Corn, Etc.)

Further, the cell (column 102, row 106) of the table 100 may be related to the esterified propoxylated glycerol. Further, the esterified propoxylated glycerol may be present in an amount ranging between 1% and 38% of the total amount of the confectionery product. Further, the esterified propoxylated glycerol may be used for substituting at least one percentage of an amount of the milkfat present in the dairy product. Further, the esterified propoxylated glycerol may be in a liquid state, a semi solid state, a solid state, etc., at a room temperature (25 degrees Celsius to 33 degrees Celsius).

Further, the cell (column 102, row 108) of the table 100 may be related to the at least one sweetener. Further, the at least one sweetener may be present in an amount ranging between 1% and 40% of the total amount of the confectionery product. Further, the total amount corresponds to the total weight, total volume, total mass, etc. Further, the at least one sweetener may substitute the lactose of the dairy product.

Further, in some embodiments, the at least one sweetener may include a natural sweetener. Further, the natural sweetener may include at least one of Allulose, Stevia, and Erythritol.

Further, in some embodiments, the confectionery product may be spreadable.

Further, in some embodiments, the at least one sweetener may include at least one of Isomaltulose and Trehalulose. Further, the at least one sweetener may be a nutritive sweetener.

Further, in some embodiments, the at least one sweetener may include one or more high potency sweeteners. Further, the one or more high potency sweeteners may include a high intensity sweetener.

In further embodiments, the confectionery product may include at least one first additional component. Further, the at least one first additional component may include at least one of one or more essential trace elements, one or more soluble oligosaccharides, and one or more bulking agents. Further, the one or more soluble oligosaccharides may include maltose, lactose, etc. Further, the one or more bulking agents may include guar gum, husk, starch, methylcellulose, sterculia, etc.

In further embodiments, the confectionery product may include at least one second additional component. Further, the at least one second additional component may include at least one of one or more gelling agents, one or more bulking sweetener agents, one or more doctoring agents, one or more flavors, one or more actives, one or more food colors, and one or more sensates. Further, the one or more gelling agents may include gelatin, gums, agar-agar, pectin, starch, etc. Further, the one or more doctoring agents may include inulin, indigestible dextrin, sucromalt, polydextrose, etc. Further, the one or more flavors may include a natural flavor ingredient, an artificial flavor ingredient, etc. Further, the one or more flavors may include maltol, furaneol, flavoring aromatics, flavor oil, etc. Further, the one or more sensate may include a cooling agent (such as Menthol, Xylitol, etc.), a warming agent (such as vanillyl alcohol n-butylether, gingerol, cinnamon oil, etc.), a tingling agent (such as effervescent, Spilanthol, etc.), etc.

In further embodiments, the confectionery product may include Tocopherol.

Further, in some embodiments, the at least one product component may include at least one of a vegetable, a fruit, a nut, a flower, and a seed. Further, the vegetable may include a carrot, ash gourd, gourd, etc. Further, the fruit may include mango, banana, one or more berries, coconut, raisins, etc. Further, the nut may include Cashews (Kaju), Almonds, Pistachios (Pista), Walnuts, etc. Further, the seed may include Watermelon seeds, Cucumber seeds, Sesame seeds, etc. Further, the flower may include Saffron (Kesar), Rose, etc. Further, the at least one product component may include spices. Further, the spices may include Saffron, Cardamom, Cinnamon, Cloves, Nutmeg, Mace, Ginger, etc.

Further, in some embodiments, the at least one product component may be present in an amount ranging between 22% and 98% of the total amount of the confectionery product.

Further, in some embodiments, the confectionery product comprising at least one of Balushahi, Besan Laddu, Gajar Halwa, Rasgulla, Gulab Jamun, Jalebi, Kalakand, Kesar Pista Barfi, Malai Peda, Doodh Peda, Kaju Barfi, Ras Malai, and Patisa (Soan Papdi).

Further, in some embodiments, wherein the esterified propoxylated glycerol is incorporated in the confectionery product through a mixture comprising the esterified propoxylated glycerol, wherein the mixture is subjected to at least one process for transforming at least one a physical characteristic, a chemical characteristic, and a composition characteristic of the mixture, wherein the transforming of at least one of the physical characteristic, the chemical characteristic, and the composition characteristic of the mixture forms the confectionery product.

Further, in some embodiments, the esterified propoxylated glycerol may be incorporated into the confectionery product through a mixture comprising the esterified propoxylated glycerol. Further, the mixture may include a solution, a colloidal, a slurry, etc. Further, the mixture may include the at least one product component. Further, the mixture may be subjected to at least one process for transforming at least one a physical characteristic, a chemical characteristic, and a composition characteristic of the mixture. Further, the physical characteristic may include a texture, a hardness, a softness, a surface texture, a stability, a consistency, etc. Further, the chemical characteristic may include a water content, a moisture content, a pH value, a state change, etc. Further, the composition characteristic may include a removal of one or more components from the mixture, a transformation of the one or more components of the mixture, etc. Further, the at least one process may include a first processing and at least one second process following the first process. Further, the first process may include homogenizing the mixture, exposing the mixture to a shear condition, etc. Further, the confectionery product does not contain globules of the esterified propoxylated glycerol. Further, the at least one second process may include acidifying the mixture and removing one or more components (whey, water, etc.) of the mixture, concentrating the mixture by removing water, applying heat to the mixture, etc. Further, the transforming of at least one of the physical characteristic, the chemical characteristic, and the composition characteristic of the mixture forms the confectionery product.

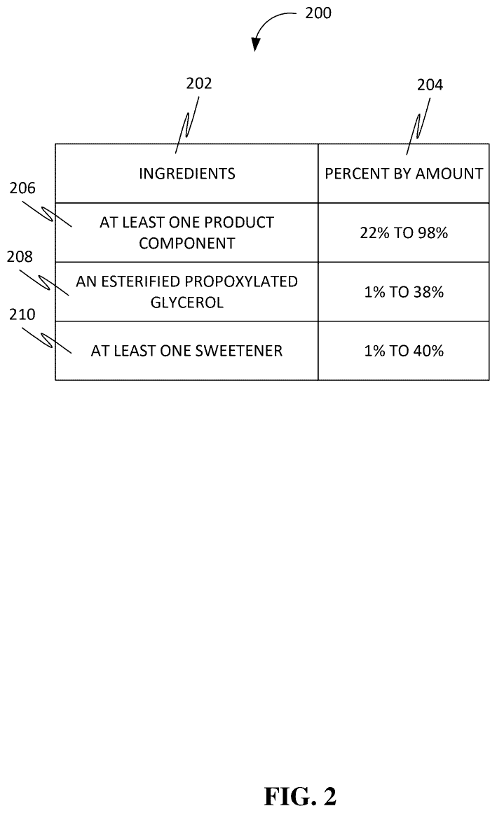

FIG. 2 is a table 200 listing the ingredients of the confectionery product, the ingredients being in percent by amount in accordance with some embodiments. Further, the table 200 may include two columns 202-204 and three rows 206-210. Further, the table 200 may include 6 cells—(column 202, row 206), (column 202, row 208), (column 202, row 210), (column 204, row 206), (column 204, row 208), and (column 204, row 210).

Further, the cell (column 202, row 206) may be related to the at least one product component. Further, the cell (column 204, row 206) shows that the confectionery product may include the at least one product component in the amount ranging between 22% and 98% of the total amount of the confectionery product.

Further, the cell (column 202, row 208) may be related to the esterified propoxylated glycerol. Further, the cell (column 204, row 208) shows that the confectionery product may include the esterified propoxylated glycerol in the amount ranging between 1% and 38% of the total amount of the confectionery product.

Further, the cell (column 202, row 210) may be related to the at least one sweetener. Further, the cell (column 204, row 210) shows that the confectionery product may include the at least one sweetener in the amount ranging between 1% and 40% of the total amount of the confectionery product.

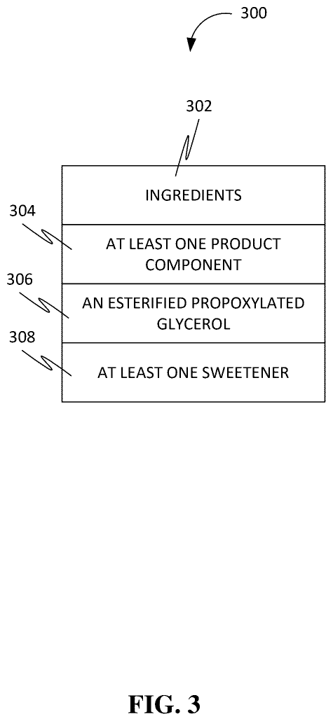

FIG. 3 is a table 300 listing ingredients of a confectionery product, in accordance with some embodiments. Further, the table 300 may include a column 302 and three rows 304-308. Further, the table 300 may include three cells (column 302, row 304), (column 302, row 306), and (column 302, row 308). Further, the confectionery product may include at least one product component, an esterified propoxylated glycerol, and at least one sweetener.

Further, a cell (column 302, row 304) of the table 300 may be related to the at least one product component. Further, the at least one product component may include at least one a dairy product and a flour of at least one of wheat and chickpea.

Further, a cell (column 302, row 306) of the table 300 may be related to the esterified propoxylated glycerol. Further, the esterified propoxylated glycerol may be present in an amount ranging between 1% and 38% of the total amount of the confectionery product.

Further, a cell (column 302, row 308) of the table 300 may be related to the at least one sweetener. Further, the at least one sweetener may be present in an amount ranging between 1% and 40% of the total amount of the confectionery product. Further, the at least one sweetener may include a natural sweetener. Further, the natural sweetener may include at least one of Allulose, Stevia, and Erythritol.

Further, in some embodiments, the at least one product component may be present in an amount ranging between 22% and 98% of the total amount of the confectionery product.

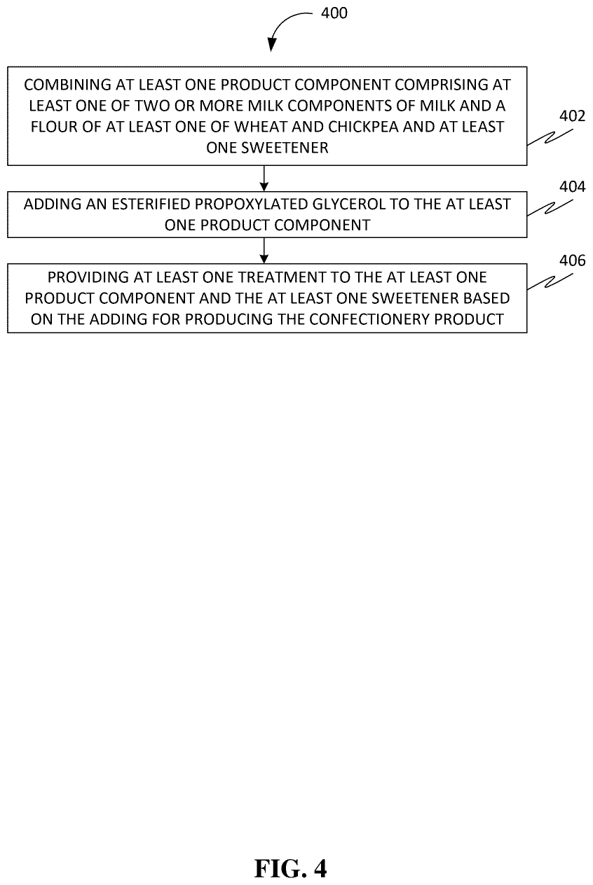

FIG. 4 is a flowchart of a method 400 for producing a confectionery product, in accordance with some embodiments. Accordingly, at 402, the method 400 may include combining at least one product component comprising at least one of a dairy product and a flour of at least one of wheat and chickpea and at least one sweetener.

Further, at 404, the method 400 may include adding an esterified propoxylated glycerol to the at least one product component.

Further, at 406, the method 400 may include providing at least one treatment to the at least one product component and the at least one sweetener based on the adding for producing the confectionery product. Further, the at least one treatment may include a heat treatment (such as boiling, frying, concentrating, cooking, etc.)

Further, in some embodiments, the at least one sweetener may include a natural sweetener. Further, the natural sweetener may include at least one of Allulose, Stevia, and Erythritol.

Further, in some embodiments, the confectionery product may be spreadable.

Further, in some embodiments, the at least one sweetener may include at least one of Isomaltulose and Trehalulose.

Further, in some embodiments, the at least one sweetener may include one or more high potency sweeteners.

Further, in some embodiments, the at least one product component may include at least one of a vegetable, a fruit, a nut, a flower, and a seed.

Further, in some embodiments, the confectionery product comprising at least one of Balushahi, Besan Laddu, Gajar Halwa, Rasgulla, Gulab Jamun, Jalebi, Kalakand, Kesar Pista Barfi, Malai Peda, Doodh Peda, Kaju Barfi, Ras Malai, and Patisa (Soan Papdi).

Although the present disclosure has been explained in relation to its preferred embodiment, it is to be understood that many other possible modifications and variations can be made without departing from the spirit and scope of the disclosure.

What is claimed is:

1. A confectionery product comprising:
at least one product component comprising at least one of a dairy product and a flour of at least one of wheat and chickpea;
an esterified propoxylated glycerol present in an amount ranging between 1% and 38% of the total amount of the confectionery product; and
at least one sweetener present in an amount ranging between 1% and 40% of the total amount of the confectionery product.

2. The confectionery product of claim 1, wherein the at least one sweetener comprises a natural sweetener, wherein the natural sweetener comprises at least one of Allulose, Stevia, and Erythritol.

3. The confectionery product of claim 1, wherein the confectionery product is spreadable.

4. The confectionery product of claim 1, wherein the at least one sweetener comprises at least one of Isomaltulose and Trehalulose.

5. The confectionery product of claim 1, wherein the at least one sweetener comprises one or more high potency sweeteners.

6. The confectionery product of claim 1 further comprising at least one first additional component, wherein the at least one first additional component comprises at least one of one or more essential trace elements, one or more soluble oligosaccharides, and one or more bulking agents.

7. The confectionery product of claim 1 further comprising at least one second additional component, wherein the at least one second additional component comprises at least one of one or more gelling agents, one or more bulking sweetener agents, one or more doctoring agents, one or more flavors, one or more actives, one or more food colors, and one or more sensates.

8. The confectionery product of claim 1 further comprising Tocopherol.

9. The confectionery product of claim 1, wherein the at least one product component further comprises at least one of a vegetable, a fruit, a nut, a flower, and a seed.

10. The confectionery product of claim 1, wherein the at least one product component is present in an amount ranging between 22% and 98% of the total amount of the confectionery product.

11. The confectionery product of claim 1, wherein the confectionery product comprising at least one of Balushahi, Besan Laddu, Gajar Halwa, Rasgulla, Gulab Jamun, Jalebi, Kalakand, Kesar Pista Barfi, Malai Peda, Doodh Peda, Kaju Barfi, Ras Malai, and Patisa (Soan Papdi).

12. A confectionery product comprising:
at least one product component comprising at least one of a dairy product and a flour of at least one of wheat and chickpea;
an esterified propoxylated glycerol present in an amount ranging between 1% and 38% of the total amount of the confectionery product; and
at least one sweetener present in an amount ranging between 1% and 40% of the total amount of the confectionery product, wherein the at least one sweetener comprises a natural sweetener, wherein the natural sweetener comprises at least one of Allulose, Stevia, and Erythritol.

13. The confectionery product of claim 12, wherein the at least one product component is present in an amount ranging between 22% and 98% of the total amount of the confectionery product.

14. A method for producing a confectionery product, the method comprising:
combining at least one product component comprising at least one of a dairy product and a flour of at least one of wheat and chickpea and at least one sweetener;
adding an esterified propoxylated glycerol to the at least one product component; and
providing at least one treatment to the at least one product component and the at least one sweetener based on the adding for producing the confectionery product.

15. The method of claim 14, wherein the at least one sweetener comprises a natural sweetener, wherein the natural sweetener comprises at least one of Allulose, Stevia, and Erythritol.

16. The method of claim 14, wherein the confectionery product is spreadable.

17. The method of claim 14, wherein the at least one sweetener comprises at least one of Isomaltulose and Trehalulose.

18. The method of claim 14, wherein the at least one sweetener comprises one or more high potency sweeteners.

19. The method of claim 14, wherein the at least one product component further comprises at least one of a vegetable, a fruit, a nut, a flower, and a seed.

20. The method of claim 14, wherein the confectionery product comprising at least one of Balushahi, Besan Laddu, Gajar Halwa, Rasgulla, Gulab Jamun, Jalebi, Kalakand, Kesar Pista Barfi, Malai Peda, Doodh Peda, Kaju Barfi, Ras Malai, and Patisa (Soan Papdi).
